(19) United States
(12) Patent Application Publication
(10) Pub. No.: US 2023/0407710 A1
(43) Pub. Date: Dec. 21, 2023

(54) Downhole signal-conducting and power-conducting flexible cable

(71) Applicant: Sigurd SOLEM, Greater ACCRA Region (GH)

(72) Inventor: Sigurd SOLEM, Greater ACCRA Region (GH)

(21) Appl. No.: 18/357,590

(22) Filed: Jul. 24, 2023

(51) Int. Cl. E21B 17/00; E21B 47/12

(52) U.S. Cl. CPC E21B 17/003; E21B 31/03; E21B 47/12

(57) ABSTRACT

Disclosed herein is a downhole signal-conducting and power-conducting flexible cable that can stretch and contract as required while remaining conductively conducted to a source and a receiver. Also disclosed is a method of conducting a signal and power downhole through said flexible cable. The flexible cable can be used with or included with downhole tools.

### CROSS-REFERENCE TO EARLIER FILED APPLICATIONS

The present application claims the benefit of Norwegian application No. NO20211438, filed Nov. 26, 2021, which issued as patent No. NO346773 on Dec. 27, 2022, the entire disclosure of which is hereby incorporated by reference.

### FIELD OF THE INVENTION

The present invention provides a downhole signal-conducting and power-conducting flexible cable that can stretch and contract as required while remaining conductively conducted to a source and a receiver. The invention also provides a method for using a downhole tool comprising a flexible electric and signal conducting cable that can stretch and contract as required while staying connected. The invention is typically used in downhole tools that have a variable length and that require one or more electrical or signal connections to go through them. Such tools are typically drilling and fishing jars, energizers, shock tools and bumper subs. The flexible conductor is adapted to carry (conduct) both power to downhole tools and two-way signal data traffic downhole. The flexible conductor is mounted between a mandrel and a washpipe to protect it from erosion caused by flow of fluids inside the pipe. The upper end of the flexible electric line is connected to the mandrel or the washpipe, and the lower end of the flexible conductor is connected to the lower housing which is below the section where the varying length takes place. This way, the flexible conductor can compensate for any length change that takes place.

### BACKGROUND OF THE INVENTION

The drilling industry is evolving into the use of wired downhole drillpipe and drilling tools for the purpose of increasing the data rate and or delivering power to downhole tools and sensors.

Wired downhole tools require one or more conductors from the surface and down to the bottom of the drillstring. In present state of the art wired drillpipe, the conductors has to pass through different types of connections (NOV, ReelWell and TDE) that allows them to be connected and isolated from short circuits. However, tools that have a varying length, jars, energizers, shock tools etc, need to have a wired connection that allows the conductor to change length dynamically and quickly.

Present technology includes coils (NOV) that are installed between the mandrel and a washpipe. Typically, when a jar is fired, the coil has a flexible length and allows the electrical and data connection to remain intact while in use. However, by using a coil, when the coil is lengthened, the diameter of the coil has to change to a smaller diameter to compensate for the change in length. Again, if the coil is shortened, the diameter must increase to compensate for the change in length. This effect means that the space where the coil will be housed or instilled in, must have enough free space to allow for the lengthening and shortening of the coil. This extra space required will influence the size of tools or the inside diameter of the washpipe. The present invention intends to solve this problem and allow for a smaller space where the conductor is installed.

NOV shows a technology for connection a wire with a flexible (U.S. Pat. No. 6,991,035B2) length that is facilitated by mounting a coil around a pipe. The coil is flexible and allows the length of the tool to change without stretching the cable. The characteristic of the coil is that it will also change diameter when changing length due to the fact that the coil accommodates the changing length by increasing the length when the cable becomes shorter and decreasing the length when the cable becomes longer. This change of diameter must be compensated for in the space that the coil is mounted. If the space is too small, the coil will touch the outer wall when decreasing the length of the coil and correspondingly decrease the diameter when the cable is lengthened. When the coil diameter is expanded without sufficient space, the coil will risk buckling and correspondingly, when the cable is elongated, the coil will snap if there is insufficient space.

Minnesota Wire and Cable teaches US 2013/0161055A1 a flexible coil in FIGS. 1-3 and a flat coil, FIG. 5. The claims also describe a retractable coil, but this patent requires heat to retract to its original length. In other words, it is only flexible once until heat is applied.

Minnesota Wire and Cable also teaches in US 2015/0257315 A1 a flexible conductor wrapped around an elastic core with a varying number of cables wrapped around as coils. The main difference between this invention and the present invention is that this invention is not hollow and is therefore unable to allow flow of a fluid go through. Every single embodiment will also undergo a change in diameter when activated. If installed between an mandrel and a washpipe, there would not be enough annular space to house it.

Other technologies, such as presented by Minnesota Cable, is flexible in length, but as the length changes, the volume of the cable must change to compensate. In U.S. Pat. No. 9,825,356 B2 the Minnesota Cable solution is basically also a coil wrapped around a flexible core. When the cable is lengthened, the core is lengthened, and the coil wrapped around the core will also lengthen but also reduce in diameter to compensate for the change in length.

U.S. Pat. No. 9,512,682 teaches a helical coil for gluing or melting into a fixed position inside a screen. No compensation for changing length is shown and this is therefore not relevant to the present invention.

WO 2020139199 A1 shows a data communication cable and various methods of connecting interfaces. The present invention is not relevant to this prior art.

US 2008003856 A1 is a patent application for a wired transmission system, related to U.S. Pat. No. 6,991,035B2, today owned by NOV. Although this is a data transmission system, it is not relevant to the present application.

### SUMMARY OF THE INVENTION

It is an object of the present invention to provide a downhole signal-conducting and power-conducting flexible cable that can stretch and contract as required while remaining conductively conducted to a source and a receiver. It is a further object of the invention to provide a method of conducting a signal and power downhole through said flexible cable. The invention also provides downhole tools employing or including said flexible cable.

### BRIEF DESCRIPTION OF THE DRAWINGS

The drawings accompanying the present invention serve to illustrate the nature of the invention. These drawings are included for purposes of illustration only and should not be understood as strictly limiting the invention claimed herein.

The drawings include the following parts: (1) Mandrel; (2) Washpipe; (3) Rubber strip; (4) Serpentined cable; (5) Fixing hole on rubber strip lower end; (6) Elongated cable upper end; (7) Fixing hole on rubber strip on upper end; (8) Elongated cable, lower end; (9) Threaded lower end of washpipe; (10) Fixing hole on 1; (11) Fixing hole on lower end of washpipe; (12) Threaded lower end of mandrel; and (13) Threaded upper end of mandrel.

FIG. 1 depicts some of the components of the flexible cable of the invention.

FIG. 2 depicts embodiments of the rubber strip and serpentine cable employed with the flexible cable.

FIG. 3 depicts an embodiment of the flexible assembled and in compressed form.

FIG. 4 depicts the flexible cable of FIG. 3 in relaxed or uncompressed form.

FIG. 5 depicts an alternate embodiment of the flexible cable of FIG. 3.

### DETAILED DESCRIPTION OF THE INVENTION

Electric line, conductor, cable, wire and coil are terms used in this application and in other patents to describe a conduit that can transmit a signal or power or both through a tool or from one tool to another or through a drillstring. For this application, the word conductor has been used to encompass said terms. Furthermore, all tools described as prior art and the present invention has at least three components in common, a mandrel, a washpipe mechanically connected with the mandrel having the washpipe installed inside it and a conductor cable. The annular space between the mandrel and the washpipe is where a conductor would normally be installed in order to protect it from flow. The mandrel and the washpipe are connected to the lower housing with a spline system that allows these two elements to change its total length when activated. This is valid for jars, energizers, shock subs, bumper subs and other tools fitted with a spline that allows axial movement.

The present invention discloses a method to mount a flexible conductor or cable between a mandrel and a washpipe. The mandrel is connected to a lower housing by a spline in such a way that the mandrel and lower housing can move or stroke in a telescopic manner without rotating independently of each other. This type of ability is used in drilling jars, shock tools, bumper subs and energizers, all downhole drilling tools. All the mentioned tools require a limited stroke to function. Further, all the tools described also require flow of mud or other fluids to go through them. A drilling jar, when in use, can stroke both up and down and the mandrel and lower housing can be accelerated either apart or towards each other to create an impact. When using a wired drillpipe system, it is necessary to convey a flexible conductor through the tool with variable length. Present technologies include U.S. Pat. No. 6,991,035B2 that teaches a flexible coil mounted between a mandrel and a wash pipe. The coil can change length when required. However, the drawback is that when a coil changes length, it also must change diameter to compensate for the change in length. This fact requires extra annular space between the mandrel and the washpipe, where it is mounted. This extra space must be compensated for by either increasing the diameter of the mandrel or decreasing the diameter of the washpipe. Any change in diameter will reduce the available space for fluid to pass through the tool and will increase the pressure losses. If the diameter of the mandrel is increased, the space between the mandrel and the borehole wall will be decreased and increase resistance to flow between the mandrel and borehole wall. This will result in an increased pressure required to circulate fluids. If the washpipe diameter is decreased to compensate for coil diameter change, the inside diameter of the reduced washpipe will cause a pressure loss inside the drillstring, increasing the required pump pressure to circulate fluids. Decreasing the washpipe diameter can also cause problems when an operator wants to access the lower part of the drillstring with a wireline to access tools, or even dropping darts and ball to activate other tools.

The present invention shows a flexible length of cable held in place by a rubber or other flexible material. The shape of the cable is serpentine and is shaped/adapted to fit between the mandrel and the washpipe. This serpentine shape allows for a change in length but does not require a change in diameter or extra reserved annular space between the mandrel and the washpipe to compensate for changing diameters. The serpentine cable can be cast into a strip of rubber or other flexible material such as EPDM and can be pre-loaded with a certain amount of stretch to compensate for changes in length, both lengthening and shortening. Some of these materials have an elasticity of several hundred percent and can be used again and again. The combination of the cable and the rubber material can also be in the form of a lattice. The preloaded stretch on the lattice is high enough to contract with sufficient speed if a tool like a drilling jar is fired and a fast-contracting effect is required. The lattice itself will have enough length and elasticity to be able to compensate for any change in length without the lattice being exposed to changes that go beyond the materials' elastic limit. Further, the rubber strip or lattice, in combination with the mandrel and the washpipe, is formed like a half shell so it fits into the annular space between the mandrel and the washpipe. The cable or conductor is enclosed in a hardened rubber or metal shield that is flexible enough to be formed into the half shell between the mandrel and the washpipe.

The upper part of the rubber strip or lattice is fixed to the mandrel or the washpipe by a bolt or other fixture device. The lower part of the rubber strip or lattice is fixed to the lower mandrel on the opposite side of the moving parts, i.e. the splined drive. This way, the flexible part of the rubber strip or lattice is free to move in synchrony with the splined drive. The lower part of the cable or conductor can also be fixed to an even lower part of the drillstring in order to cross one or more moving parts without losing power or signal. The thickness of the cable or conductor can be adjusted to what the end user requires. If a thicker cable or conductor is required, the serpentine part of the cable or conductor can be elongated to suit requirements. Further, if a longer axial movement or flexibility is required, the rubber strip or lattice can be elongated as needed.

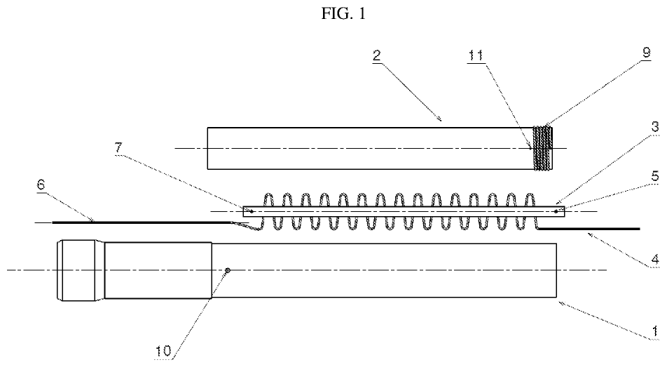

FIG. 1 depicts some of the main aspects of the invention. The mandrel (1) has a washpipe (2) mounted inside it. The mandrel (1) and washpipe (2) can move independently of each other. The washpipe (2) has a threaded upper end (9) that can be mechanically connected to a upper string member. This string member is not shown as it is not part of the present invention. Between the mandrel (1) and washpipe (2), a flexible cable (4) is cast into a rubber strip (3). The rubber strip (3) and serpentine cable (4) can be flexible in length when stretched. The rubber strip (3) has a fixing hole (5) that allows it to connect to a fixing hole (11) in the washpipe (2). Further, the rubber strip has a fixing hole in the upper end (7) that allows it to be connected to the mandrel (1) through another fixing hole (10). This way, any axial movement between the mandrel (1) and washpipe (2) will cause the rubber strip (3) and serpentined cable (4) to stretch or contract in unison. The lower part of the rubber strip (3) does not necessarily have to be connected to fixing holes (7) and (10). In most cases in tools such as a drilling jar, there is another part of a tool that has a variable length. In order to compensate for this variation of length, the fixing holes (7) and (10) are not used, but instead, there is an elongation of the cable (6) that is elongated past the tools variable length section and is fixed to the bottom of the tool with variable length properties. The functionality is the same, but the lower fixing point has been moved further down the string.

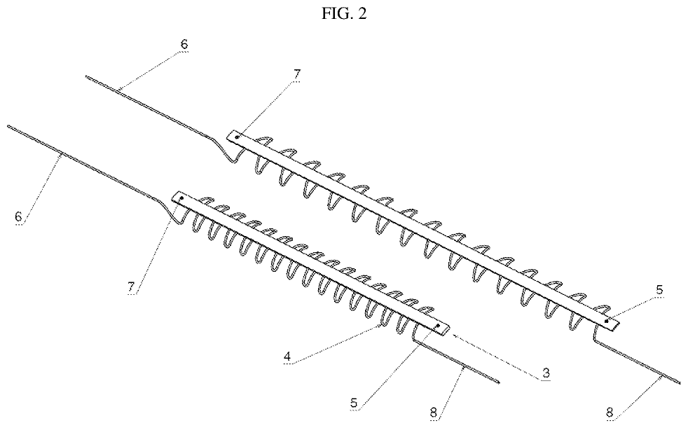

FIG. 2 depicts details of the rubber strip (3) and serpentine cable (4). When the length of the mandrel (1) and washpipe (2) is changed, the rubber strip (3) will elongate or contract as required, without changing the length of the serpentine cable (4). The fixing point (5) in the upper part of the rubber strip (4) fixes the rubber strip (4) to the washpipe. The lower fixing point does not have to be used if a further tool with variable length is in the immediate closeness to the present invention. Then an elongated cable (6) is elongated past the other variable length parts and fixed to the bottom of the tool. Further, an elongated cable (8) in the upper part of the rubber strip (3) can be elongated to an upper connection point that is not part of the tool. A further possibility is that neither fixing holes (5) and (7) are used and the cable elongations 6 and 8 are fixed to other tools with cable connections.

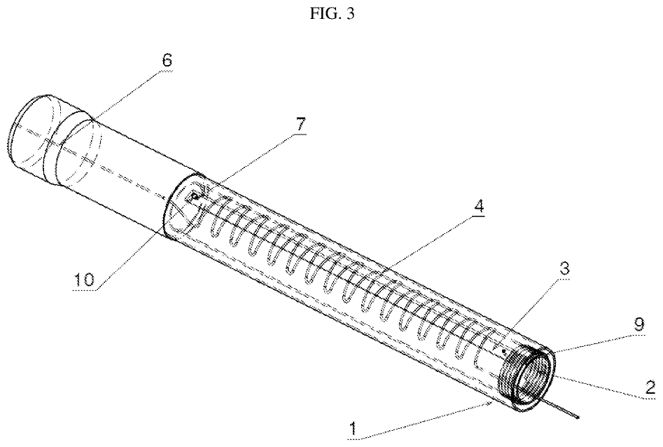

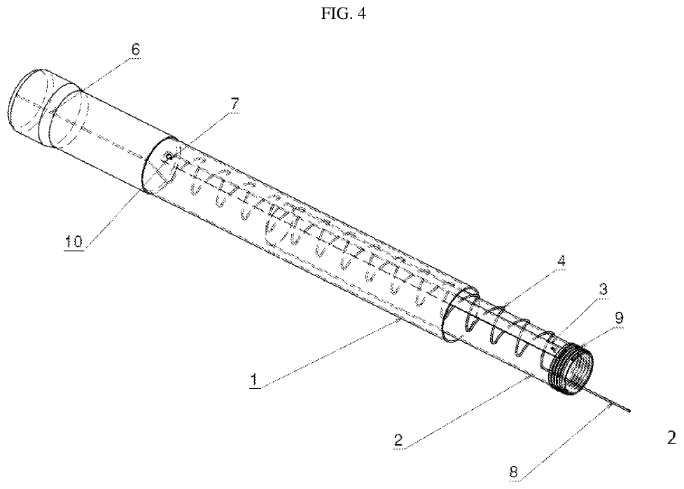

FIGS. 3 and 4 shows the assembled tool in relaxed and extended position. In this view, one can see how the rubber strip (3) and serpentine cable (4) elongate and contract as the mandrel (1) and washpipe (2) move apart or together. Further, the rubber strip (3) and serpentine cable (4) can have tension preloaded in such a way that it will contract much faster than if it did not have preloaded tension.

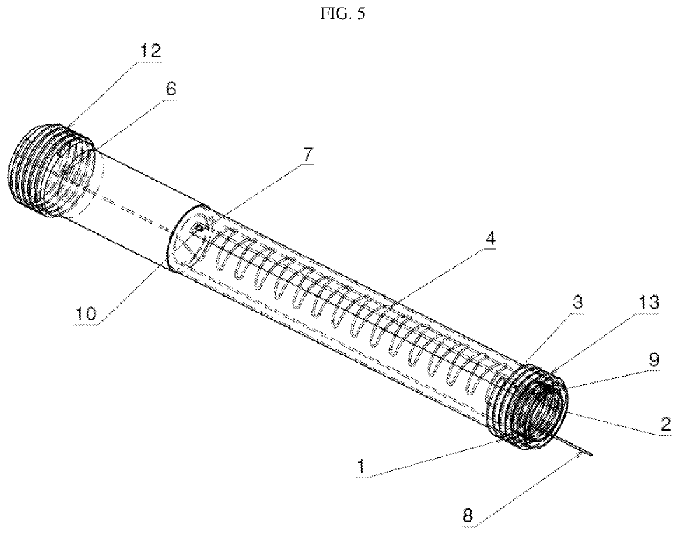

FIG. 5 shows preferred embodiment of the invention, where the mandrel (1) and washpipe (2) connected at the upper end and by not using fixing holes (7) and (10) and by using the elongated cable (6) to fix the lower end to the lower part of the variable length tool, the mandrel has threads (12 and 13) in each end of mandrel (1) that allows it to the connected to bother the upper part of the string, but also the lower part of the string.

1. A method for conveying a signal and power through a flexible cable, said cable comprising:
a. an electrical and signal conducting cable i) formed like a serpent; ii) cast into a rubber strip; iii) installed between a mandrel and a washpipe; and iv) shaped into a half shell to fit between said mandrel and washpipe;
wherein i) the upper part of the rubber strip is fixed to the mandrel or washpipe; and ii) the lower part of the rubber strip is fixed to a lower mandrel or other part of the string located below the moving parts of the drive spline and held in position by a flexible rubber material and held in suspension so it can either expand or contract.

2. The method of claim 1, said cable comprises two cables located on one half circle each.

3. The method of claim 2, wherein the flexible rubber is replaced by a lattice.

4. The method of claim 1, wherein the flexible rubber is replaced by a lattice.

5. The method of claim 1, wherein the electrical and signal cable is replaced by a two lead or more cables providing multiple independent signals and/or power transfer.

6. The method of claim 1, wherein said cable comprises two or more conductors mounted in the same rubber compound.

7. A flexible cable for conveying one or more signals and power therethrough, said flexible cable comprising:
a. an electrical and signal conducting cable i) formed like a serpent; ii) cast into a rubber strip; iii) installed between a mandrel and a washpipe; and iv) shaped into a half shell to fit between said mandrel and washpipe;
wherein i) the upper part of the rubber strip is fixed to the mandrel or washpipe; and ii) the lower part of the rubber strip is fixed to a lower mandrel or other part of the string located below the moving parts of the drive spline and held in position by a flexible rubber material and held in suspension so it can either expand or contract.

8. The flexible cable of claim 1, said cable comprises two cables located on one half circle each.

9. The flexible cable of claim 2, wherein the flexible rubber is replaced by a lattice.

10. The flexible cable of claim 1, wherein the flexible rubber is replaced by a lattice.

11. The flexible cable of claim 1, wherein the electrical and signal cable is replaced by a two lead or more cables providing multiple independent signals and/or power transfer.

12. The flexible cable of claim 1, wherein said cable comprises two or more conductors mounted in the same rubber compound.
